(19) United States
(12) Patent Application Publication
(10) Pub. No.: US 2024/0395079 A1
(43) Pub. Date: Nov. 28, 2024

(54) SYSTEMS AND METHODS OF DETERMINING DRIVING ATTRIBUTES

(71) Applicant: Allstate Insurance Company, Northbrook, IL (US)

(72) Inventors: Daniel Brian Mohnen, Grayslake, IL (US); Derek Wong, Wheaton, IL (US); Ravi Shukla, Livingston, NJ (US); Henry Kowal, Simsbury, CT (US); Andrew Agustin, Peachtree Corners, GA (US); Cory Luitjohan, Forest Park, IL (US)

(21) Appl. No.: 18/200,065

(22) Filed: May 22, 2023

(51) Int. Cl. G07C 5/02

(52) U.S. Cl. CPC G07C 5/02

(57) ABSTRACT

Implementations claimed and described herein provide systems and methods for determining driving attributes using telematics data. The systems and methods use telematics data generated via a telematics device disposed in a vehicle. One or more driving attributes associated with a vehicle operator and/or the vehicle based on the telematics data are determined by the system. The one or more driving attributes associated with the vehicle operator and/or the vehicle are denormalized and aggregated. Furthermore, the aggregated driving attributes are communicated with a provider computing device in response to a request for the aggregated driving attributes.

### FIELD

Aspects of the presently disclosed technology relate generally to driving data based on telematics data. More specifically, aspects of this disclosure relate to systems and methods for capturing and communicating driving data based on telematics data to determine driving attributes.

### BACKGROUND

People and organizations, such as insurance companies, financial institutions, or service providers, may collect and/or analyze vehicle telematics data for a variety of purposes. Vehicle telematics data includes various data from measurements related to a vehicle's operation. For example, vehicle telematics data may include global positioning system (GPS) coordinates of an automobile that allow the location of the automobile to be tracked. Also, for example, vehicle telematics data may include acceleration data of an automobile that allows the speed of the automobile to be tracked. Providers may use this information, in some examples, to evaluate the risk of customers and potential customers. Other organizations may also be interested in such information to determine a person's driving behavior.

However, conventional systems do not allow for a third party, such as service providers, to evaluate the risk of potential customers at the time of sale. Instead, the service providers must track the telematics data over a long period of time, e.g., several months, before an accurate calculation may be made by the provider's model to determine a driver score, which affects coverage eligibility, premiums, etc. As such, driver scores calculated using conventional systems require a long data collection period before an accurate result can be calculated. It is with these observations in mind, among others, that various aspects of the present disclosure were conceived and developed.

### SUMMARY

Implementations described and claimed herein address the foregoing problems by providing systems and methods for determining driving attributes using telematics data. For instance, a computer implemented method can comprise: receiving telematics data, the telematics data generated by a telematics device disposed within a vehicle; determining driving attributes based on the telematics data; combining and denormalizing the driving attributes to create denormalized attributes; aggregating the denormalized attributes for a time period to create aggregated attributes; and communicating the aggregated attributes to a provider computing device responsive to receiving a request from the provider computing device for the aggregated attributes, the aggregated attributes configured to be input into a provider model to calculate a driver score.

In some implementations, a system comprises: one or more databases storing telematics data generated by a telematics device disposed within a vehicle; and a driving assessment platform including at least one processor configured to: receive the telematics data; determine driving attributes based on the telematics data; combining and denormalizing the driving attributes to create denormalized attributes; aggregating the denormalized attributes for a time period to create aggregated attributes; and sending the aggregated attributes to one or more databases, wherein the aggregated attributes are communicated to a provider computing device responsive to receiving a request from the provider computing device for the aggregated attributes, the aggregated attributes configured to be input into a provider model to calculate a driver score.

In some instances, one or more tangible non-transitory computer-readable storage media store computer-executable instructions for performing a computer process on a computing system, the computer process comprising: receiving telematics data, the telematics data generated by a telematics device disposed within a vehicle; determining driving attributes based on the telematics data; combining and denormalizing the driving attributes to create denormalized attributes; aggregating the denormalized attributes for a time period to create aggregated attributes; sending the aggregated attributes to one or more databases; and communicating the aggregated attributes from the one or more databases to a provider computing device responsive to receiving a request from the provider computing device for the aggregated attributes, the aggregated attributes configured to be input into a provider model to calculate a driver score.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example system to determine driving attributes using different types of telematics data.

FIG. 2 illustrates an example system to determine driving attributes using different types of telematics data.

FIG. 3 illustrates an example system to determine driving attributes using different types of telematics data and one or more computing devices.

FIG. 4 illustrates an example method to determine driving attributes using different types of telematics data.

### DETAILED DESCRIPTION

Aspects of the present disclosure involve systems and methods to determine driving attributes using telematics data. The systems and methods described herein use telematics data generated by telematics device(s) to determine driving attributes that can be communicated to a provider, such as a service provider or a financial institution, to allow the provider to determine a driver score using a model of the provider. This results in the driver score being available at time of purchase of a service, while allowing the provider to use their own proprietary model. Additional advantages of the presently disclosed technology will become apparent from the detailed description below.

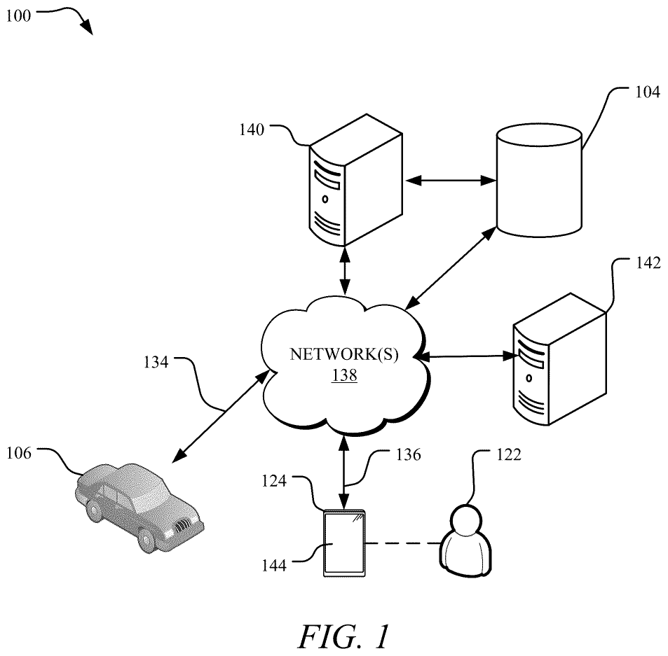

To begin a detailed description of an example system 100 to determine driving attributes using telematics data, reference is made to FIGS. 1-4. The system 100 can include a driving assessment platform 102 in communication with one or more databases 104. The driving assessment platform 102 can receive multiple, different types of telematics data 108 regarding a vehicle 106 from the one or more databases 104 using different types of data connections. Upon receiving the telematics data 108, the driving assessment platform 102 can perform operations to transform the telematics data 108 into driving attributes 110. The driving assessment platform 102 can also receive additional data from the one or more databases 104 to determine removed trips 120 that should not be used to calculate a driver score. The additional data including one or more of trip removal data 112, vehicle mode data 114, drive passenger data 116, and user updates data 118.

Trip removal data 112 can include data acquired during driving trips that are below a time and/or distance threshold, driving trips conducted during inclement weather, etc. Vehicle mode data 114 can include data indicating whether the vehicle 106 is driven manually, autonomously, or semi-autonomously. Drive passenger data 116 can indicate when a user 122 is a passenger in the vehicle 106. User updates data 118 can include data related to updates to an account of the user 106.

The vehicle 106 can be, for example, an automobile, motorcycle, scooter, bus, recreational vehicle, boat, or other vehicle for which sensor or crash data can be collected and analyzed. A telematics device disposed within the vehicle 106 can be used to collect and/or receive sensor data and/or to receive sensor data from the vehicle 106. The telematics device can process the data to detect a crash or non-crash event and/or transmit the sensor or crash data to the one or more databases 104 or other computing devices. The telematics device can be a computing device of the vehicle 106 or one or more mobile computing devices 124, for example, mobile phones, personal digital assistants (PDAs), tablet computers, laptop computers, smartwatches, and other devices that can be carried by drivers or passengers inside or outside of the vehicle 106. The telematics device can also be integrated into the vehicle 106 and/or connected to a data bus within the vehicle 106 via an on-board diagnostics (OBD) device installed in a vehicle 106, such as, an OBD-II device that can generate data corresponding to various OBD parameter IDS (OBD-II PIDs) which can be defined by Society of Automotive Engineers (SAE) standards.

The telematics device can receive a variety of data, such as acceleration, velocity, location, vehicle operation data such as braking, turning, swerving, and the like from vehicle sensors located within the telematics device and/or vehicle 106. The vehicle sensors can include fuel level sensors, tire pressure sensors, engine temperature sensors, a global positioning system (GPS) sensor, a global navigation satellite system (GNSS), an onboard computer tracking systems, etc. Additionally or alternatively, the telematics data 108 can originate and/or be received from the one or more mobile computing devices 124 associated with the user 122. Additionally or alternatively, the telematics device includes a Global Positioning System (GPS) receiver that can determine vehicle location, speed, direction and other basic driving data without needing to communicate with the vehicle sensors or external vehicle systems. However, it should be noted that any of a variety of other location determination techniques, such as location determined based on wireless networks to which the one or more mobile computing devices 124 is connected, such as Wi-Fi networks, cellular networks, and the like, can also be used. The sensors of the telematics device, such as a GPS and/or a compass, can sense the speed and/or direction at which the telematics device (and accordingly vehicle 106) is traveling. An accelerometer of the telematics device can sense the acceleration of the one or more mobile computing devices 124. A gyroscope can be used to determine the orientation of the one or more mobile computing devices 124. In some aspects, orientation can be detected, for example, at a rate of 90 Hz. The gyroscope can also be used to measure the speed of rotation of the telematics device. A magnetometer can be used to measure the strength and direction of the magnetic field relative to the telematics device. The data collected by the telematics device can be stored and/or analyzed within the telematics device. The processing components of the telematics device can be used to analyze sensor data, determine that a crash has or has not occurred, and confirm whether or not the crash has occurred. Additionally or alternatively, the telematics device can transmit, via a wired or wireless transmission network, the data to one or more databases 104 for storage and/or analysis. In an implementation, the telematics device transmits data only when it detects that a crash has occurred.

In an implementation, the telematics data 108 includes speed data 126, acceleration data 128, braking data 130, and/or location data 132. The telematics data 108 can be transmitted to the one or more databases 104 on a rolling basis, on a batch basis (e.g., every month, every six months, every 12 months, etc.), responsive to an interface call for data, responsive to an interface requesting data in response to detecting consumer activity, or the like. The one or more databases 104 can receive and store the telematics data 108 with the associated timestamps for later retrieval by the driving assessment platform 102. Values of the speed data 126, acceleration data 128, braking data 130, and/or location data 132 can be extracted from the telematics data 108. The telematics data 108 can be associated with the vehicle 106 independently from any associations with the user 122, and/or the telematics data 108 can be associated with both the vehicle 106 and the one or more mobile computing devices 124 associated with the user 122 operating the vehicle 106 at the time the telematics data 108 is generated (e.g., by using a Bluetooth sync, a trip match with a previous trip start or trip end point, or the like).

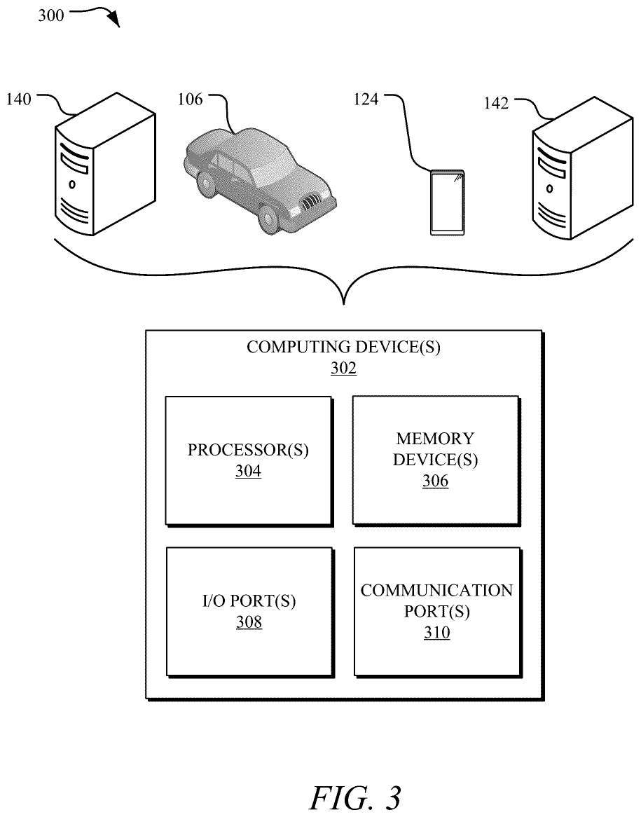

In an implementation where the telematics data 108 is generated and/or sent from the one or more mobile computing devices 124 associated with the user 122 while the user 122 is operating the vehicle 106, an application operating on the one or more mobile computing devices 124 can use the various sensor and hardware components of the one or more mobile computing devices 124 to generate and/or send the telematics data 108 to the one or more databases 104. In some instances, the application is received at the one or more mobile computing devices 124 from the driving assessment platform 102 (e.g., via an application store) in response to a request to join a driving assessment program or procedure (e.g., as part of an onboarding process). The telematics data 108 can include data generated using a global positioning system (GPS) sensor, an accelerometer sensor, a camera, a microphone, or any other components of the one or more mobile computing devices 124 (e.g., which are discussed in greater detail below regarding FIG. 3). As such the telematics data 108 can be formatted to correspond to an operating system of the one or more mobile computing devices 124 (e.g., iOS®, Android®, etc.). The telematics data 108 can be timestamped and/or associated with the user 122 based on the association between the user 122 and the one or more mobile computing devices 124.

The one or more databases 104 can receive the telematics data 108 by way of one or more of a first connection 134 between the one or more databases 104 and the vehicle 106 (e.g., formed by an OBD device) and a second connection 136 between the one or more databases 104 and the one or more mobile computing devices 124. The first connection 134 and the second connection 136 can be established using the respective communication ports of the vehicle 106 and the one or more mobile computing devices 124 discussed below regarding FIG. 3. For instance, the first connection 134 and the second connection 136 are established via one or more network(s) 138. The network(s) 138 can be any combination of one or more of a cellular network such as a 3rd Generation Partnership Project (3GPP) network, a third generation (3G) network, a fourth generation (4G) network, a fifth generation (5G) network, a Long-Term Evolution (LTE), an LTE Advanced Network, a Global System for Mobile Communications (GSM) network, a Universal Mobile Telecommunications System (UMTS) network, and the like. Moreover, the network(s) 138 can include any type of network, such as the Internet, an intranet, a Virtual Private Network (VPN), a Voice over Internet Protocol (VOIP) network, a wireless network (e.g., Bluetooth), a cellular network, a satellite network, combinations thereof, etc. The network(s) 138 can provide access to and interactions with the one or more databases 104 for the telematics device. The network(s) 138 can include communications network components such as, but not limited to gateways routers, servers, and registrars, which enable communication across the network(s) 138. In one implementation, the communications network components include multiple ingress/egress routers, which may have one or more ports, in communication with the network(s) 138.

Furthermore, the driving assessment platform 102 can be operated by server device(s) 140 hosting software, application(s), websites, and the like for receiving the telematics data 108 from the one or more databases 104, and/or analyzing this data to determine driving attributes 110. The server device(s) 140 may be a single server, a plurality of servers with each such server being a physical server or a virtual machine, or a collection of both physical servers and virtual machines. In another implementation, a cloud hosts one or more components of the driving assessment platform 102. The server device(s) 140 may represent an instance among large instances of application servers in a cloud computing environment, a data center, or other computing environment. The server device(s) 140 can access data stored at one or more database(s) 104 (e.g., including any of the data, values, and associations discussed herein, such as telematics data 108, trip removal data 112, vehicle mode data 114, drive passenger data 116, user updates data 118, etc. stored in the one or more databases 104). The server device(s) 140 can determine the driving attributes 110 using the retrieved data, combine and denormalize the driving attributes into denormalized attributes, aggregating the denormalized attributes for a time period (e.g., a week, a month, etc.) into aggregated attributes, and send the aggregated attributes to one or more databases 104 for storage. The data associated with the removed trips 120 is not denormalized and aggregated. The aggregated attributes are communicated to a provider computing device 142 in response to a request for the data responsive to the user 122 requesting quote or purchase of a service provided by the provider. The aggregated attributes can then be used as inputs for a provider model to generate a driver score at time of purchase.

The driving assessment platform 102 executing on the server device(s) 140, and/or other resources connected to the network(s) 138, may access one or more other servers to access other websites, applications, web services interfaces, storage devices, APIs, computing devices, or the like to perform the techniques discussed herein. For instance, a first server (e.g., the server device(s) 140) can receive and aggregate the telematics data 108 from the one or more databases 104. This server can perform the analytics discussed herein on the telematics data 108 to generate driving attributes 110, which can then be transmitted to a second server (e.g., the provider computing device 142. The second server can use the driving attributes 110 in a model to determine a driver rating or score of the user 122 at the time of purchase of a service provided by the provider. The provider may use the driver rating or score to perform analyses and determinations (e.g., determine coverage, calculate premiums and deductibles, award safe driver discounts, etc.).

For instance, the driving assessment platform 102 executing on the server device(s) 140 can perform analytical operations to generate the driving attributes 110 for the vehicle 106 and/or the user 122. In some instances, the driving assessment platform 102 uses the telematics data 108 to determine or generate the driving attributes 110 corresponding to the user 122, the vehicle 106, and/or one or more additional vehicle operators associated with the user 122 and/or the vehicle 106. The driving attributes 110 can be combined and denormalized to denormalized attributes. The denormalized attributes are aggregated for a defined time period (e.g., a week, month, etc.) to aggregated attributes. The aggregated attributes can be sent to the provider computing device in response to a request for data. The aggregated attributes can be implemented into a model executed by the provider computing device to generate a driver score.

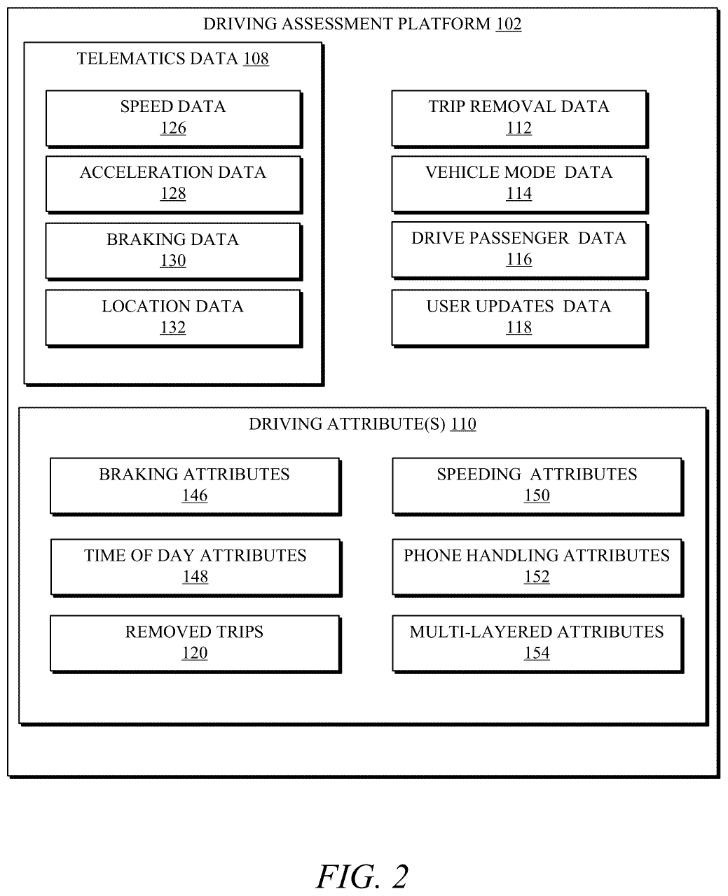

Moreover, various data types discussed herein can be presented at a user interface (UI) 144. In some instances, a user input at the UI 144 can be received by the driving assessment platform 102 indicating, for instance, that the user 122 is or would like to use the services of the driving assessment platform 102, and/or received by the provider computing device 142 indicating that the user 122 would like a quote for or to purchase a service provided by the provider. Furthermore, the one or more databases 104 can receive the telematics data 108 (e.g., from a vehicle connection and a mobile connection, respectively) and can send the telematics data 108 and additional data to the driving assessment platform 102 for aggregation and denormalizing prior to being sent to the provider computing device 142 for use in calculating a driver score. The network 138 connecting these components, so that the data can be transmitted on the backend, can also provide a frontend user experience. For instance, the driving attributes 110 can be presented at the UI 144 in an easily digestible format to encourage safe driving behavior. The UI 144 can also allow the user to select which services the user 122 desires a quote for or to purchase. The driver score calculated by the provider computing device 142 can be displayed on the UI 144, along with the cost of the service. These and various other operations are discussed in greater detail below regarding FIGS. 2-4.

FIG. 2 illustrates the driving assessment platform 102 to assess driving behavior using different types of telematics data and additional data to generate the driving attributes 110. The different types of telematics data can include speed data 126, acceleration data 128, braking data 130, location data 132, and combinations thereof. The additional data can include trip removal data 112, vehicle mode data 114, drive passenger data 116, user updates data 118, and combinations thereof. Using combinations of the different types of data, the driving assessment platform 102 can generate the driving attributes 110, which can correspond to the user 122, the vehicle 106, additional plurality of vehicle operators, and/or combinations thereof.

The driving assessment platform 102 can generate the driving attributes 110 by weighing, combining, and performing other analytical techniques on the telematics data 108 and the additional data. For instance, the driving assessment platform 102 can determine braking attributes 146 determined by detecting and/or averaging one or more deceleration events and/or a speed at time of braking (e.g., based on the speed data 126); time of day attributes 148 which can include an average driving time of day over many driving events or a particular range for driving time of day for a particular driving event; speeding attributes 150, which can include a percent of miles above or below a speed limit determined over a predetermined amount of time or distance; phone handling attributes 152 (e.g., based on detecting phone usage activity occurring while driving); and/or removed trips 120 that are determined based on the additional data (e.g., trip removal data 112, vehicle mode data 114, drive passenger data 116, user updates data 118, and combinations thereof). The granularity of the individual driving attributes 110 can be based on a client configuration for a client model used to calculate a driver score.

In some examples, the driving attributes 110 can be associated together (e.g., based on matching corresponding timestamps) and/or associated with other information accessible to the driving assessment platform 102 to create multi-layered attributes 154. This can provide additional information on which the driving score can be calculated without sharing private location data of the user 122 with the provider computing device 142. For instance, the driving assessment platform 102 can determine a contextual speed (e.g., a vehicle speed with respect to the speed limit), contextual braking (vehicle braking with respect to the speed limit); contextual speed and/or contextual braking with respect to the driving time of day; and combinations thereof. As such, the driving assessment platform 102 can generate a more complete, sophisticated, and personalized driving assessment for the user 122 operating the vehicle 106 without sharing sensitive location data. In an implementations, the each of the driving attributes 110 are processed in parallel.

Turning to FIG. 3, a system 300 to display driving data using telematics data can include one or more computing device(s) 302 for performing the techniques discussed herein. In one implementation, the one or more computing device(s) 302 include the server device(s) 140, the telematics device disposed in the vehicle 106, the computing device of the vehicle 106, the mobile computing device 124, the provider computing device 142, and/or other computing devices associated with the vehicle 106, the user 122, the additional vehicle operator(s), and/or the provider to generate and execute the driving assessment platform 102 as a software application and/or a module or algorithmic component of software.

In some instances, the computing device(s) 302 can include a computer, a personal computer, a desktop computer, a laptop computer, a terminal, a workstation, a server device, a cellular or mobile phone, a mobile device, a smart mobile device a tablet, a wearable device (e.g., a smart watch, smart glasses, a smart epidermal device, etc.) a multimedia console, a television, an Internet-of-Things (IoT) device, a smart home device, a medical device, a virtual reality (VR) or augmented reality (AR) device, a vehicle (e.g., a smart bicycle, an automobile computer, etc.), and/or the like. The computing device(s) 302 may be integrated with, form a part of, or otherwise be associated with the systems 100-300. It will be appreciated that specific implementations of these devices may be of differing possible specific computing architectures not all of which are specifically discussed herein but will be understood by those of ordinary skill in the art.

The computing device 302 may be a computing system capable of executing a computer program product to execute a computer process. Data and program files may be input to the computing device 302, which reads the files and executes the programs therein. Some of the elements of the computing device 302 include one or more hardware processors 304, one or more memory devices 306, and/or one or more ports, such as input/output (IO) port(s) 308 and communication port(s) 310. Additionally, other elements that will be recognized by those skilled in the art may be included in the computing device 302 but are not explicitly depicted in FIG. 3 or discussed further herein. Various elements of the computing device 302 may communicate with one another by way of the communication port(s) 310 and/or one or more communication buses, point-to-point communication paths, or other communication means.

The processor 304 may include, for example, a central processing unit (CPU), a microprocessor, a microcontroller, a digital signal processor (DSP), and/or one or more internal levels of cache. There may be one or more processors 304, such that the processor 304 comprises a single central-processing unit, or a plurality of processing units capable of executing instructions and performing operations in parallel with each other, commonly referred to as a parallel processing environment.

The computing device 302 may be a conventional computer, a distributed computer, or any other type of computer, such as one or more external computers made available via a cloud computing architecture. The presently described technology is optionally implemented in software stored on the data storage device(s) such as the memory device(s) 306, and/or communicated via one or more of the I/O port(s) 308 and the communication port(s) 310, thereby transforming the computing device 302 in FIG. 3 to a special purpose machine for implementing the operations described herein and generating the. Moreover, the computing device 302, as implemented in the systems 100-300, receives various types of input data (e.g., the telematics data 108) and transforms the input data through various stages of the data flow into new types of data files (e.g., the driving attributes 110) Moreover, these new data files are transformed further into instructions that are sent to cause the driving attributes to be combined and denormalized and then aggregated over a time period, which enables the computing device 302 to do something it could not do before—communicate aggregated driving attributes to a provider computer device for use in a provider model for calculating driver scores for the user 122 or vehicle 106 at time of purchase of a service.

Additionally, the systems and operations disclosed herein represent an improvement to the technical field of vehicle telematics and sensor verification. For instance, the driving assessment platform 102 can provide for the usage of more granular data across different data sources, and with built in redundancies, such that more advanced driving attributes 110 can be calculated, and with improved accuracy (e.g., a reduced error range). Moreover, data can be leveraged from different data sources with varying levels of abstraction to provide a highly customized delivery of granular driving attribute 110 data that can be used in complex models of a provider. These techniques are rooted in technology and could not have existed prior to the advent of vehicle telematics and/or sensor data analytics.

The one or more memory device(s) 306 may include any non-volatile data storage device capable of storing data generated or employed within the computing device 302, such as computer executable instructions for performing a computer process, which may include instructions of both application programs and an operating system (OS) that manages the various components of the computing device 302. The memory device(s) 306 may include, without limitation, magnetic disk drives, optical disk drives, solid state drives (SSDs), flash drives, and the like. The memory device(s) 306 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory device(s) 306 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the memory device(s) 306 which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computing device 302 includes one or more ports, such as the I/O port(s) 308 and the communication port(s) 310, for communicating with other computing, network, or vehicle computing devices. It will be appreciated that the I/O port 308 and the communication port 310 may be combined or separate and that more or fewer ports may be included in the computing device 302.

The I/O port 508 may be connected to an I/O device, or other device, by which information is input to or output from the computing device 302. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing device 302 via the I/O port 308. Similarly, the output devices may convert electrical signals received from the computing device 302 via the I/O port 308 into signals that may be sensed as output by a human, such as sound, light, and/or touch. The input device may be an alphanumeric input device, including alphanumeric and other keys for communicating information and/or command selections to the processor 304 via the I/O port 308. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing device 302 via the I/O port 308. For example, an electrical signal generated within the computing device 302 may be converted to another type of signal, and/or vice-versa. In one implementation, the environment transducer devices sense characteristics or aspects of an environment local to or remote from the computing device 302, such as, light, sound, temperature, pressure, magnetic field, electric field, chemical properties, physical movement, orientation, acceleration, gravity, and/or the like.

In one implementation, the communication port 310 is connected to the network 138 so the computing device 302 can receive network data useful in executing the methods and systems set out herein as well as transmitting information and network configuration changes determined thereby. Stated differently, the communication port 310 connects the computing device 302 to one or more communication interface devices configured to transmit and/or receive information between the computing device 302 and other devices by way of one or more wired or wireless communication networks or connections. Examples of such networks or connections include, without limitation, Universal Serial Bus (USB), Ethernet, Wi-Fi, Bluetooth®, Near Field Communication (NFC), and so on. One or more such communication interface devices may be utilized via the communication port 310 to communicate with one or more other machines, either directly over a point-to-point communication path, over a wide area network (WAN) (e.g., the Internet), over a local area network (LAN), over a cellular network (e.g., third generation (3G), fourth generation (4G), Long-Term Evolution (LTE), fifth generation (5G), etc.) or over another communication means. Further, the communication port 310 may communicate with an antenna or other link for electromagnetic signal transmission and/or reception.

In an example, the driving assessment platform 102, and/or other software, modules, services, and operations discussed herein may be embodied by instructions stored on the memory devices 306 and executed by the processor 304.

The system set forth in FIG. 3 is but one possible example of a computing device 302 or computer system that may be configured in accordance with aspects of the present disclosure. It will be appreciated that other non-transitory tangible computer-readable storage media storing computer-executable instructions for implementing the presently disclosed technology on a computing system may be utilized. In the present disclosure, the methods disclosed may be implemented as sets of instructions or software readable by the computing device 302.

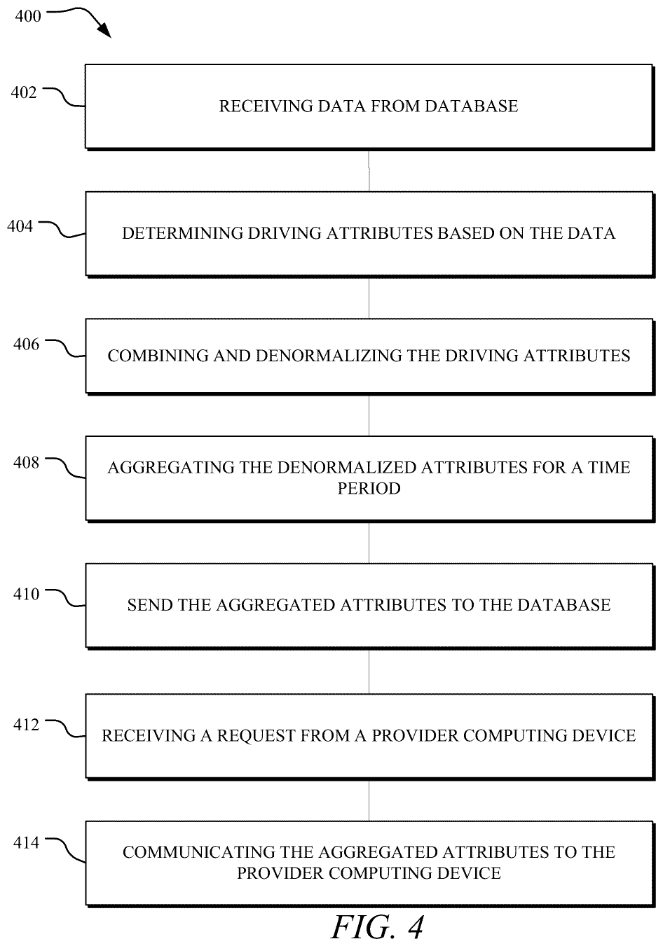

FIG. 4 depicts an example method 400 to determine driving attributes using telematics data, which can be performed by any of the systems 100-300 discussed herein.

At operation 402, the method 400 can receive data, such as telematics data 108, trip removal data 112, vehicle mode data 114, drive passenger data 116, user updates data 118, and combinations thereof, from one or more databases 104. At operation 404, the method 400 can determine driving attributes 110 associated with an operator of the vehicle, such as the user 122, and/or associated with the vehicle 106 based on the telematics data 108. At operation 406, the method 400 can combine and denormalize the driving attributes 110 for each event date to create denormalized attributes. At operation 408, the method 400 can aggregate the denormalized attributes together for a time period, e.g., a week, month, etc. to create aggregated attributes associated with the time period. At operation 410, the method 400 can send the aggregated attributes to the one or more databases 104 for storage. In an implementation, 26 weeks are stored in the one or more databases 104. At operation 412, the method 400 can receive a request from the provider computing device 142 for the aggregated attributes. At operation 414, the method 400 communicates the aggregated attributes to the provider computing device 142 for use in a provider model to determine a driver score for the user 122 and/or vehicle 106.

It is to be understood that the specific order or hierarchy of operations in the methods depicted in FIG. 4 and throughout this disclosure are instances of example approaches and can be rearranged while remaining within the disclosed subject matter. For instance, any of the operations depicted in FIG. 4 may be omitted, repeated, performed in parallel, performed in a different order, and/or combined with any other of the operations depicted in FIG. 4 or discussed herein.

Furthermore, any term of degree such as, but not limited to, “substantially,” as used in the description and the appended claims, should be understood to include an exact, or a similar, but not exact configuration. Similarly, the terms “about” or “approximately,” as used in the description and the appended claims, should be understood to include the recited values or a value that is three times greater or one third of the recited values. For example, about 3 mm includes all values from 1 mm to 9 mm, and approximately 50 degrees includes all values from 16.6 degrees to 150 degrees.

Lastly, the terms “or” and “and/or,” as used herein, are to be interpreted as inclusive or meaning any one or any combination. Therefore, “A, B, or C” or “A, B, and/or C” mean any of the following: “A,” “B,” or “C”; “A and B”; “A and C”; “B and C”; “A, B and C.” An exception to this definition will occur only when a combination of elements, functions, steps or acts are in some way inherently mutually exclusive.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A computer implemented method comprising:
receiving telematics data, the telematics data generated by a telematics device disposed within a vehicle;
determining driving attributes based on the telematics data;
combining and denormalizing the driving attributes to create denormalized attributes;
aggregating the denormalized attributes for a time period to create aggregated attributes; and
communicating the aggregated attributes to a provider computing device responsive to receiving a request from the provider computing device for the aggregated attributes, the aggregated attributes configured to be input into a provider model to calculate a driver score.

2. The method of claim 1, wherein the telematics device is a computing device of the vehicle.

3. The method of claim 1, wherein the telematics device is an on-board diagnostics device installed at the vehicle.

4. The method of claim 1, wherein the telematics device is a mobile computing device.

5. The method of claim 1, wherein the telematics data generated by the telematics device include one or more of speed data, acceleration data, braking data, and location data.

6. The method of claim 1, wherein the driving attributes include one or more of: braking attributes, time of day attributes, speeding attributes, and phone handling attributes.

7. The method of claim 1, further comprising:
receiving additional data; and
determining removed trips based on the additional data.

8. The method of claim 1, further comprising sending the aggregated attributes to one or more databases.

9. A system comprising:
a driving assessment platform including at least one processor configured to:
receive telematics data generated by a telematics device disposed within a vehicle;
determine driving attributes based on the telematics data;
combining and denormalizing the driving attributes to create denormalized attributes;
aggregating the denormalized attributes for a time period to create aggregated attributes; and
sending the aggregated attributes to one or more databases, wherein the aggregated attributes are communicated to a provider computing device responsive to receiving a request from the provider computing device for the aggregated attributes, the aggregated attributes configured to be input into a provider model to calculate a driver score.

10. The system of claim 9, wherein the telematics device is a computing device of the vehicle.

11. The system of claim 9, wherein the telematics device is an on-board diagnostics device installed at the vehicle.

12. The system of claim 9, wherein the telematics device is a mobile computing device.

13. The system of claim 9, wherein the telematics data include one or more of: speed data, acceleration data, braking data, and location data.

14. The system of claim 9, wherein the driving attributes include one or more of: braking attributes, time of day attributes, speeding attributes, and phone handling attributes.

15. The system of claim 9, wherein the driving assessment platform including the at least one processor is further configured to:
receive additional data from the one or more databases; and
determine removed trips based on the additional data.

16. One or more tangible non-transitory computer-readable storage media storing computer-executable instructions for performing a computer process on a computing system, the computer process comprising:
receiving telematics data, the telematics data generated by a telematics device disposed within a vehicle;
determining driving attributes based on the telematics data;
combining and denormalizing the driving attributes to create denormalized attributes;
aggregating the denormalized attributes for a time period to create aggregated attributes;
sending the aggregated attributes to the one or more databases; and
communicating the aggregated attributes from one or more databases to a provider computing device responsive to receiving a request from the provider computing device for the aggregated attributes, the aggregated attributes configured to be input into a provider model to calculate a driver score.

17. The one or more tangible non-transitory computer-readable storage media storing computer-executable instructions for performing the computer process on the computing system of claim 16, wherein the telematics data include one or more of: speed data, acceleration data, braking data, and location data.

18. The one or more tangible non-transitory computer-readable storage media storing computer-executable instructions for performing the computer process on the computing system of claim 16, wherein the driving attributes include one or more of: braking attributes, time of day attributes, speeding attributes, and phone handling attributes.

19. The one or more tangible non-transitory computer-readable storage media storing computer-executable instructions for performing the computer process on the computing system of claim 16, the computer process further comprising:
receiving additional data from the one or more databases; and
determining removed trips based on the additional data.

20. The one or more tangible non-transitory computer-readable storage media storing computer-executable instructions for performing the computer process on the computing system of claim 16, wherein the telematics device is one of: a computing device of the vehicle or a mobile computing device.
